(19) United States
(12) Patent Application Publication
(10) Pub. No.: US 2011/0061056 A1
(43) Pub. Date: Mar. 10, 2011

(54) PORTABLE DEVICE AND METHOD FOR PROVIDING SHORTCUTS IN THE PORTABLE DEVICE

(75) Inventor: DING-CAI SHU, Shenzhen City (CN)

(73) Assignees: SHENZHEN FUTAIHONG PRECISION INDUSTRY CO., LTD., ShenZhen City (CN); Chi Mei Communication Systems, Inc., Tu-Cheng City (TW)

(21) Appl. No.: 12/820,027

(22) Filed: Jun. 21, 2010

(30) Foreign Application Priority Data
Sep. 10, 2009 (CN) 200910306831.0

(51) Int. Cl. G06F 3/048; G06F 9/46

(52) U.S. Cl. 718/103; 715/835; 715/809

(57) ABSTRACT

A method and a portable device provide shortcuts in an operating system of the portable device. The method displays the shortcuts in a user interface of the operating system on a display unit of the portable device when a first process is operating in the portable device. An application menu corresponding to the shortcut is displayed when the shortcut is activated, where the application menu comprises a list of a plurality of applications. The first process is executed as a background process when one of the applications is selected on the user interface as a second process, and the second process is executed as a foreground process.

### BACKGROUND

1. Technical Field

The present disclosure relates to a portable device and a method for providing shortcuts in an operating system of the portable device.

2. Description of Related Art

Portable devices store various applications to be executed. Generally, users have to terminate a foreground application and then he/she may choose another application from the main menu so as to select another application to operate. However, such operating behavior wastes too much time, especially in case of another application is disposed in a sub-menu of the main menu.

Accordingly, an improved portable device and method are called for in order to overcome the limitations described.

### BRIEF DESCRIPTION OF THE DRAWINGS

FIG. 1 is a block diagram of one embodiment of a portable device.

FIG. 2 is an example of a shortcut displayed in an operation window.

FIG. 3 is an exemplary embodiment of an application menu corresponding to a shortcut.

FIG. 4 is a flowchart illustrating one embodiment of a method for providing a shortcut in an operating system of the portable device.

### DETAILED DESCRIPTION

In general, the word “unit” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

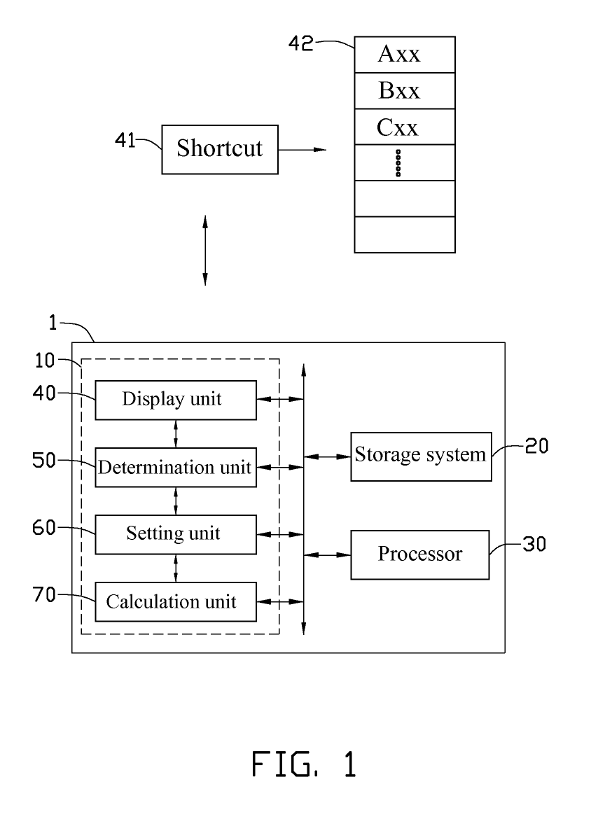

FIG. 1 is a block diagram of one embodiment of a portable device 1 comprising a system 10. The system 10 is operable to provide a shortcut 41 in a user interface of an operating system of the portable device 1. The system 10 provides a ready operation for activating functions and applications. The portable device 1 may include mobile phones, PDAs, or DSCs, for example. The portable device 1 further includes a storage system 20, a processor 30, a display unit 40, a determination unit 50, a setting unit 60, and a calculation unit 70. The processor 30 may execute one or more programs stored in the storage unit 20 to provide functions for the display unit 40, the determination unit 50, the setting unit 60, and the calculation unit 70.

The portable device 1 is generally controlled and coordinated by an operating system, such as UNIX, Linux, Windows, Mac OS, an embedded operating system, or any other compatible system. Alternatively, the portable device 1 may be controlled by a proprietary operating system. Typical operating systems control and schedule computer processes for execution, perform memory management, provide file system, networking, and I/O services, and provide a user interface, such as a graphical user interface (GUI), among other tasks.

The display unit 40 is operable to display the shortcut 41 in a user interface of the portable device 1 when a first process is operating in the operating system as a foreground process and display an application menu 42 corresponding to the shortcut 41 when the shortcut 41 is activated. The application menu 42 includes a list of a plurality of applications of the portable device 1. The display unit 40 may be a display, such as an LCD, for example.

The processor 30 is further operable to execute the first process as a background process when one of the applications is selected on the user interface as a second process, execute the second process as a foreground process, and restore the first process as the foreground process when the second process is terminated.

The calculation unit 70 is operable to calculate an operation count of the background process. After the second process is executed, the calculation unit 70 adds one to the operation count. When the second process is terminated, the calculation unit 70 subtracts one from the operation count.

The setting unit 60 is operable to set a threshold k. The determination unit 50 is operable to determine whether the operation count is greater than or equal to the threshold k. The display unit 40 displays an alert window on the user interface to indicate an overflow of the background process if the operation count is greater than or equal to the threshold k. In one embodiment, the threshold k is set to be 2. In this way, the performance of the portable device is stable as only two background processes are suspended.

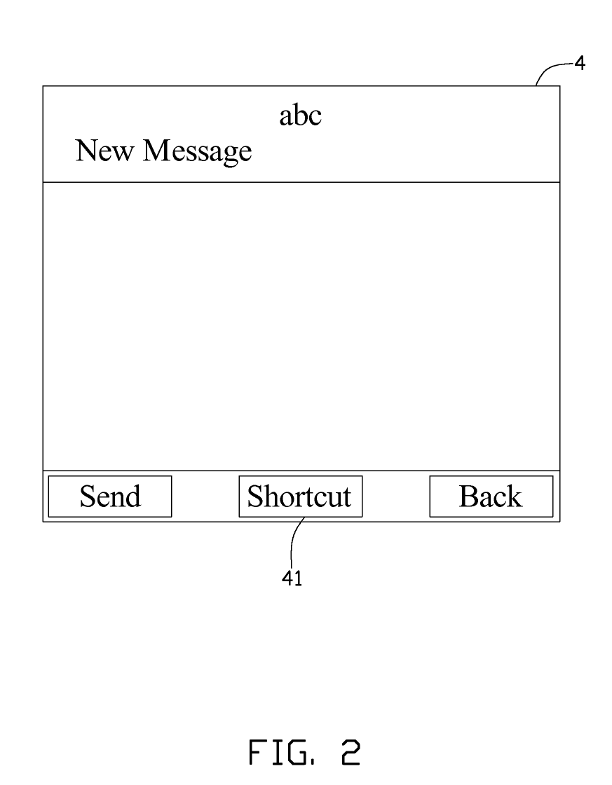

FIG. 2 is an example of the shortcut 41 displayed on an operation window 4. The operation window 4 relates to an editing window of a short message of a mobile phone. The editing window relates to the first process.

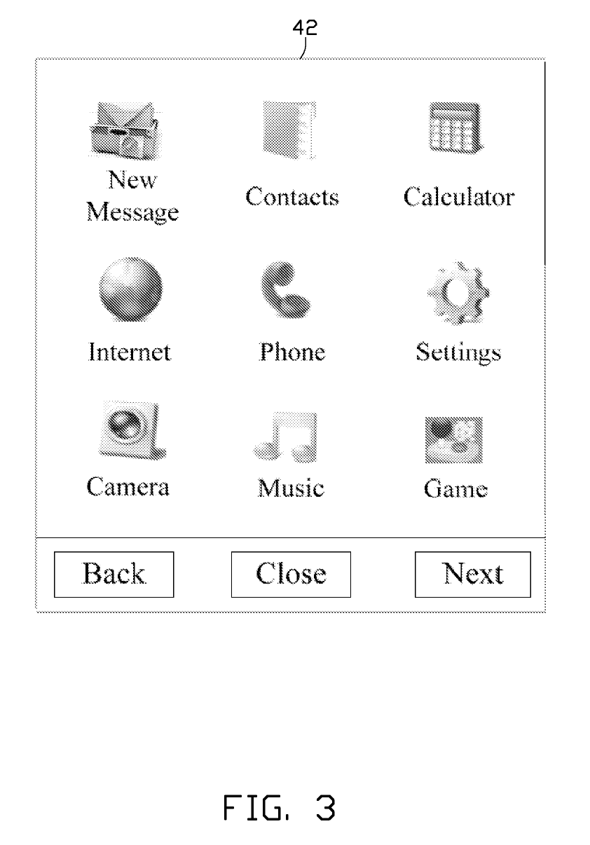

FIG. 3 is an exemplary embodiment of the application menu 42 corresponding to the shortcut 41. The application menu 42 may be displayed when the shortcut 41 is activated. The application menu 42 includes a list of a plurality of applications. One of the applications is selected to be the second process.

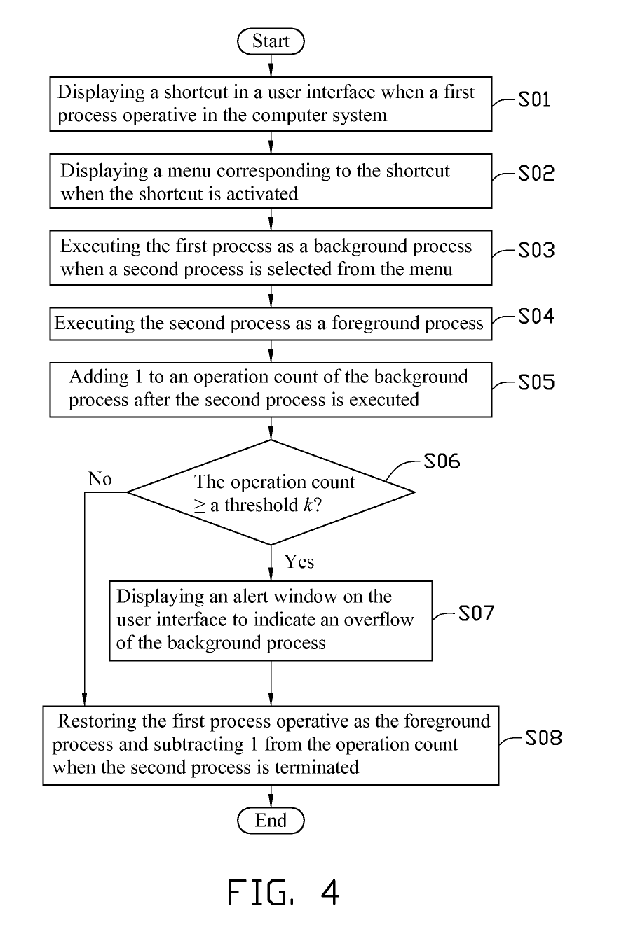

FIG. 4 is a flowchart illustrating a method for providing the shortcut 41 in the operating system of the portable device. Depending on the embodiment, additional blocks in the flow of FIG. 4 may be added, others removed, and the ordering of the blocks may be changed.

In block S01, the display unit 40 displays the shortcut 41 in the user interface when the first process is operative as the foreground process in the operating system.

In block S02, the display unit 40 displays the application menu 42 corresponding to the shortcut 41 when the shortcut 41 is activated. The application menu 42 includes a list of a plurality of applications.

In block S03, when one of the applications is selected as the second process from the application menu 42, the processor 30 executes the first process as the background process.

In block S04, the processor 30 executes the second process as the foreground process.

In block S05, after the second process is executed, the calculation unit 70 adds one to the operation count of the background process.

In block S06, the determination unit 50 determines whether the operation count is greater than or equal to the threshold k. If the operation count is smaller than the threshold k, the process goes to block S08.

In block S07, if the operation count is greater than or equal to the threshold k, the display unit 40 displays the alert window on the user interface to indicate the overflow of the background process.

In block S08, when the second process is terminated, the processor 30 restores the first process as the foreground process. In addition, the calculation unit 70 subtracts one from the operation count.

The present disclosure provides a shortcut in a user interface to readily activate other applications when a first process is operating in a portable device. Convenient operation for the portable device is provided.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for providing a shortcut in an operating system of a portable device, the method comprising:
displaying the shortcut in a user interface of the operating system on a display unit of the portable device when a first process is operating in the operating system as a foreground process;
displaying an application menu corresponding to the shortcut on the display unit when the shortcut is activated, the application menu comprising a list of a plurality of applications of the portable device;
executing the first process as a background process when one of the applications is selected on the user interface as a second process; and
executing the second process as the foreground process.

2. The method of claim 1, further comprising:
restoring the first process as the foreground process when the second process is terminated.

3. The method of claim 2, further comprising:
setting a threshold k; and
calculating an operation count of the background process.

4. The method of claim 3, further comprising:
adding one to the operation count after the second process is executed.

5. The method of claim 4, further comprising:
subtracting one from the operation count when the second process is terminated.

6. The method of claim 5 further comprising:
determining whether the operation count is greater than or equal to the threshold k; and
displaying an alert window on the user interface to indicate an overflow of the background process if the operation count is greater than or equal to the threshold k.

7. A portable device, comprising:
a storage unit;
at least one processor;
one or more programs stored in the storage unit and being executable by the at least one processor;
a display unit operable to display the shortcut in a user interface of the portable device when a first process is operating in the portable device as a foreground process, and display an application menu corresponding to the shortcut when the shortcut is activated, the application menu comprises a list of a plurality of applications;
a determination unit operable to determine whether the shortcut is activated; and wherein
the processor is operable to execute the first process as a background process when one of the applications is selected as a second process to be executed as a foreground process.

8. The portable device of claim 7, wherein the processor is further operable to restore the first process as the foreground process when the second process is terminated.

9. The portable device of claim 8, further comprises a setting unit operable to set a threshold k.

10. The portable device of claim 9, further comprises a calculation unit operable to calculate an operation count of the background process, add one to the operation count after the second process is executed, and subtract one from the operation count when the second process is terminated.

11. The portable device of claim 10, wherein the determination unit further determines whether the operation count is greater than or equal to the threshold k.

12. The portable device of claim 11, wherein the display unit further displays an alert window on the user interface to indicate an overflow of the background process if the operation count is greater than or equal to the threshold k.

13. A storage medium having stored thereon instructions that, when executed by a processor, causing the processor to perform method for providing a shortcut in an operating system of a portable device, wherein the method comprises:
display the shortcut in a user interface of the operating system on a display unit of the portable device when a first process is operating in the operating system as a foreground process;
display an application menu corresponding to the shortcut on the display unit when the shortcut is activated, the application menu comprises a list of a plurality of applications of the portable device;
execute the first process as a background process when one of the applications is selected on the user interface as a second process; and
execute the second process as the foreground process.

14. The storage medium of claim 13, wherein the method comprises:
restore the first process as the foreground process when the second process is terminated.

15. The storage medium of claim 14, wherein the method comprises:
set a threshold k; and
calculate an operation count of the background process.

16. The storage medium of claim 15, wherein the method comprises:
add one to the operation count after the second process is executed.

17. The storage medium of claim 16, wherein the method comprises:
subtract one from the operation count when the second process is terminated.

18. The storage medium of claim 17, wherein the method comprises:
determine whether the operation count is greater than or equal to the threshold k; and
display an alert window on the user interface to indicate an overflow of the background process if the operation count is greater than or equal to the threshold k.
